(19) United States
(12) Patent Application Publication
(10) Pub. No.: US 2025/0159630 A1
(43) Pub. Date: May 15, 2025

(54) CAPABILITY INDICATION METHOD AND APPARATUS, CAPABILITY DETERMINATION METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/725,209

(22) PCT Filed: Dec. 31, 2021
(86) PCT No.: PCT/CN2021/143930

§ 371 Date: Jun. 28, 2024

(51) Int. Cl. H04W 56/00; H04W 8/24; H04W 28/06

(52) U.S. Cl. CPC H04W 56/0045; H04W 8/24; H04W 28/06

(57) ABSTRACT

A method, apparatus and computer readable medium for indicating and determining the capability of a terminal to support uplink transmission timing advance pre-compensation for segment-based transmission in a wireless communication system. The capability of the terminal is determined by: transmitting capability indication information to a network-side device, where the capability indication information is configured to indicate a capability of the terminal to support uplink transmission timing advance pre-compensation for segment-based transmission.

### CROSS REFERENCE TO RELATED APPLICATIONS

This application is a National Phase of International Application No. PCT/CN2021/143930, filed on Dec. 31, 2021, the entire contents of which are incorporated herein by reference in their entirety.

### TECHNICAL FIELD

The present disclosure relates to the field of communication technologies, and in particular to a capability indication method and apparatus, a capability determination method and apparatus, a communication device, and a computer-readable storage medium.

### BACKGROUND

In non-terrestrial networks (NTN), a terminal can communicate with a base station via a satellite. A timing advance (TA) to be compensated for is larger because the satellite is moving through the air and is farther away from the terminal. At present, the terminal can determine a part of the timing advance that needs to be compensated by the terminal (the network side can compensate the other part of the timing advance), and the terminal can pre-compensate the timing advance by means of uplink transmission timing advance pre-compensation.

In addition, to provide communication efficiency, the terminal, when performing uplink transmission, such as transmitting a physical uplink share channel (PUSCH), may transmit a long PUSCH, which can be understood as the time domain resource occupied by the transmitting the PUSCH is relatively long.

In this case, the information to be transmitted can be transmitted in segments. For example, when transmitting the long PUSCH, the information to be transmitted can be divided into a plurality of segments, and the uplink transmission can be carried out separately for each of the plurality of segments.

Considering the timing advance compensation, for each of the plurality of segments, it is necessary to pre-compensate the uplink transmission timing advance when the uplink transmission is carried out, which can be called uplink transmission timing advance pre-compensation for segment-based transmission.

Since the uplink transmission timing advance pre-compensation for segment-based transmission needs to pre-compensate the timing advance for each of the plurality of segments separately, the operation is relatively complicated, so not all terminals support the uplink transmission timing advance pre-compensation for segment-based transmission.

### SUMMARY

According to a first aspect of an embodiment of the present disclosure, there is provided a capability indication method, performed by a terminal, and including: transmitting capability indication information to a network-side device, where the capability indication information is configured to indicate a capability of the terminal to support uplink transmission timing advance pre-compensation for segment-based transmission.

According to a second aspect of an embodiment of the present disclosure, there is provided a capability determination method, performed by a network-side device, and including: receiving capability indication information transmitted by a terminal; and determining, based on the capability indication information, a capability of the terminal to support uplink transmission timing advance pre-compensation for segment-based transmission.

According to a third aspect of an embodiment of the present disclosure, there is provided a communication device, including: a processor; and a memory storing computer programs, where the computer programs, when executed by the processor, cause the processor to perform the above-mentioned capability indication method.

According to a fourth aspect of an embodiment of the present disclosure, there is provided a communication device, including: a processor; and a memory storing computer programs, where the computer programs, when executed by the processor, cause the processor to perform the above-mentioned capability determination method.

According to a fifth aspect of an embodiment of the present disclosure, there is provided a non-transitory computer-readable storage medium, storing computer programs thereon, where the computer programs, when executed by a processor, cause the processor to perform the above-mentioned capability indication method.

According to a sixth aspect of an embodiment of the present disclosure, there is provided a non-transitory computer-readable storage medium, storing computer programs thereon, where the computer programs, when executed by a processor, cause the processor to perform the above-mentioned capability determination method.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other drawings from these accompanying drawings without inventive efforts.

FIG. 1 is a flowchart illustrating a capability indication method according to an embodiment of the present disclosure.

FIG. 2 is a flowchart illustrating a capability indication method according to another embodiment of the present disclosure.

FIG. 3 is a schematic diagram illustrating segments with an overlap according to an embodiment of the present disclosure.

FIG. 4 is a schematic diagram illustrating segments without overlap according to an embodiment of the present disclosure.

FIG. 5 is a flowchart illustrating a capability indication method according to yet another embodiment of the present disclosure.

FIG. 6 is a flowchart illustrating a capability indication method according to still another embodiment of the present disclosure.

FIG. 7 is a flowchart illustrating a capability indication method according to still another embodiment of the present disclosure.

FIG. 8 is a flowchart illustrating a capability indication method according to still another embodiment of the present disclosure.

FIG. 9 is a flowchart illustrating a capability determination method according to an embodiment of the present disclosure.

FIG. 10 is a flowchart illustrating a capability determination method according to another embodiment of the present disclosure.

FIG. 11 is a flowchart illustrating a capability determination method according to yet another embodiment of the present disclosure.

FIG. 12 is a flowchart illustrating a capability determination method according to still another embodiment of the present disclosure.

FIG. 13 is a flowchart illustrating a capability determination method according to still another embodiment of the present disclosure.

FIG. 14 is a block diagram illustrating a capability indication apparatus according to an embodiment of the present disclosure.

FIG. 15 is a block diagram illustrating a capability indication apparatus according to another embodiment of the present disclosure.

FIG. 16 is a block diagram illustrating a capability determination apparatus according to an embodiment of the present disclosure.

FIG. 17 is a block diagram illustrating a device for determining a capability according to an embodiment of the present disclosure.

FIG. 18 is a block diagram illustrating a device for indicating a capability according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

For purposes of brevity and ease of understanding, the wordings “greater than” or “less than”, “higher than” or “lower than” are used herein to characterize size relationships. However, for those skilled in the art, it will be understood that the wording “greater than” covers the meaning of “greater than or equal to”, and the wording “less than” covers the meaning of “less than or equal to”. The wording “higher than” covers the meaning of “higher than or equal to”, and the wording “lower than” covers the meaning of “lower than or equal to”.

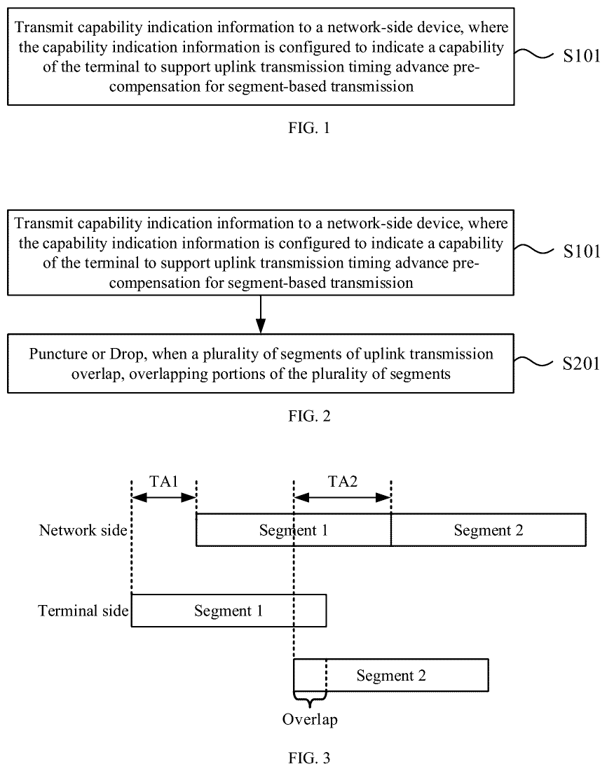

FIG. 1 is a flowchart illustrating a capability indication method according to an embodiment of the present disclosure. The capability indication method shown in this embodiment may be performed by a terminal. The terminal includes, but is not limited to, a communication device such as a cell phone, a tablet, a wearable device, a sensor, an internet of things (IoT) device, and the like. The terminal may communicate with a network-side device, the network-side device includes, but is not limited to a network-side device (such as a base station, a core network, and the like) in a communication system such as a 4th generation (4G) communication system, a 5G communication system, a 6G communication system, etc.

As shown in FIG. 1, the method may include step S101.

At step S101, capability indication information is transmitted to a network-side device, where the capability indication information is configured to indicate a capability of the terminal to support uplink transmission timing advance pre-compensation for segment-based transmission.

In an embodiment, the terminal may determine its own capability to support the uplink transmission timing advance pre-compensation for segment-based transmission, and the capability includes supporting the uplink transmission timing advance pre-compensation for segment-based transmission, and not supporting the uplink transmission timing advance pre-compensation for segment-based transmission. Further, the capability indication information is transmitted to the network-side device, and the network-side device may determine, based on the capability indication information, the capability of the terminal to support the uplink transmission timing advance pre-compensation for segment-based transmission. For example, the network-side device can determine that the terminal supports the uplink transmission timing advance pre-compensation for segment-based transmission, or determine that the terminal does not support the uplink transmission timing advance pre-compensation for segment-based transmission.

For example, the capability can be indicated by one bit, where “1” means that the terminal supports the uplink transmission timing advance pre-compensation for segment-based transmission, and “0” means that the terminal does not support the uplink transmission timing advance pre-compensation for segment-based transmission.

According to the present disclosure, that the network-side device determines the capability of the terminal to support the uplink transmission timing advance pre-compensation for segment-based transmission can be ensure, such that the terminal can be appropriately configured based on the capability of the terminal to support the uplink transmission timing advance pre-compensation for segment-based transmission, therefore good communication quality is ensured.

FIG. 2 is a flowchart illustrating a capability indication method according to another embodiment of the present disclosure. As shown in FIG. 2, the method further includes step S201.

At step S201, when a plurality of segments of uplink transmission overlap, overlapping portions of the plurality of segments are punctured or dropped.

In an embodiment, in a scenario where a terminal performs uplink transmission based on segments, the terminal may divide the uplink transmission (e.g., PUSCH, physical random access channel (PRACH), etc.) into a plurality of segments. When the terminal supports the uplink transmission timing advance pre-compensation for segment-based transmission, the uplink transmission timing advance pre-compensation may be performed separately for each segment, which may result in overlap between the compensated segments. In this case, the terminal needs to puncture or drop the overlapping portions of the segments, i.e., on the time domain resource corresponding to the overlapping portions, a resource of only one segment is transmitted, and a resource of the other segment on the time domain resource is not transmitted, such that confusion in the uplink transmission is avoided.

Illustrated by the example of two segments (e.g., segment 1 and segment 2) in the plurality of segments, the overlapping and non-overlapping situations of segments are illustrated respectively.

FIG. 3 is a schematic diagram illustrating segments with overlap according to an embodiment of the present disclosure.

As shown in FIG. 3, for the network side, the segment 1 precedes the segment 2 in the time domain. When the terminal supports the uplink transmission timing advance pre-compensation for segment-based transmission, the uplink transmission timing advance pre-compensation may be performed separately for the segment 1 and the segment 2, e.g., a timing advance pre-compensated for the segment 1 is TA1, and a timing advance pre-compensated for the segment 2 is TA2.

For example, when there is no gap in the time domain between the segment 1 and the segment 2 before the pre-compensation, and TA2 is greater than TA1, there is a portion of the pre-compensated segment 2 that overlaps with the pre-compensated segment 1 in the time domain. In this case, the terminal needs to puncture or drop the portion of the pre-compensated segment 1 that overlaps with the pre-compensated segment 1, i.e., on the time domain resource corresponding to the overlapping portion, information of only the segment 1 is transmitted, and information of the segment 2 on this time domain resource is not transmitted.

It is to be noted that the terminal may also, optionally, puncture or drop a portion of the pre-compensated segment 1 that overlaps with the pre-compensated segment 2, i.e., on the time domain resource corresponding to the overlapping portion, information of only the segment 2 is transmitted, and information of the segment 1 on this time domain resource is not transmitted.

With respect to the segments with overlapping portions, the terminal can determine, independently, or based on a configuration of the network-side device, or based on a protocol agreement, the specific choice that is to puncture or drop the relatively earlier segment in the time domain (such as the segment 1), or to puncture or drop the relatively later segment in the time domain (such as the segment 2).

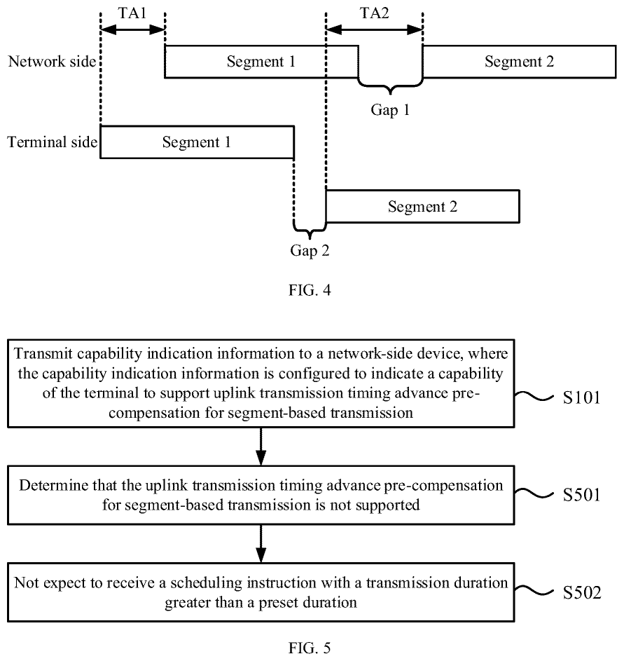

FIG. 4 is a schematic diagram illustrating segments without overlap according to an embodiment of the present disclosure.

It is to be noted that, in some cases, the uplink transmission timing advance pre-compensation is performed for the segment 1 and the segment 2 respectively, even if TA2 is greater than TA1, the segment 2 and the segment 1 may not overlap. For example, as shown in FIG. 4, there is a gap, e.g., a gap 1, between the segment 1 and the segment 2 in the time domain before the pre-compensation, and since the gap 1 is large enough, after the pre-compensation for the segment 1 based on TA1 and the pre-compensation for the segment 2 based on TA2, there is still a gap, e.g., a gap 2, between the segment 2 and the segment 1, such that there is no overlap between the segment 1 and the segment 2 after the pre-compensation.

In an embodiment, the capability indication information, when indicating that the terminal supports the uplink transmission timing advance pre-compensation for segment-based transmission, is further configured to indicate that the terminal supports puncturing or dropping the overlapping portions of the plurality of segments based on a first time domain granularity.

In an embodiment, the terminal performs the uplink transmission on time domain resource, which include a plurality of time domain granularities from large to small, and puncturing or dropping the overlapping portions of the plurality of segments by the terminal may be puncturing or dropping the overlapping portions of the plurality of segments based on a first time domain granularity, i.e., determining a time domain resource of the first time domain granularity corresponding to the overlapping portion, and then puncturing or dropping information within the determined time domain resource of the segment where the overlapping portion to be punctured or dropped is.

However, due to different capabilities of different terminals, some terminals can puncture or drop a relatively large amount of information, i.e., the first time domain granularity is relatively large when the overlapping portions of the plurality of segments are punctured or dropped based on the first time domain granularity; some terminals can only puncture or drop relatively little information, i.e., the first time domain granularity is relatively small when the overlapping portions of the plurality of segments are punctured or dropped based on the first time domain granularity.

Thus, the terminal may indicate, by the capability indication information, that the terminal supports puncturing or dropping the overlapping portions of the plurality of segments based on the first time domain granularity, such that the network-side device can determine the first time domain granularity, and thereby determine a size of the time domain granularity on which the terminal can puncture or drop the overlapping portions of the segments, so that the network-side device can appropriately configure the terminal based on the first time domain granularity, therefore good communication quality is ensured.

In an embodiment, the first time domain granularity includes at least one of:
a time domain symbol (e.g., orthogonal frequency division multiplexing (OFDM) symbol), a time slot, a subframe.

Illustrated by the example of the embodiment shown in FIG. 3, the portion of the pre-compensated segment 2 that overlaps with the segment 1 corresponds to six time domain symbols. When the first time domain granularity is a time domain symbol, only the overlapping portion of the segment 2 may be punctured or dropped. When the first time domain granularity is a time slot, it may determine a time slot in which the six time domain symbols are located, and thus further determine that the information of the segment 2 in this time slot shall be punctured or dropped. When the first time domain granularity is a subframe, it may determine a subframe in which the six time domain symbols are located, and thus further that the information of the segment 2 in this subframe shall be punctured or dropped.

In an embodiment, where the capability indication information is configured to indicate both the capability of the terminal to support the uplink transmission timing advance pre-compensation for segment-based transmission, and to indicate that the terminal supports puncturing or dropping the overlapping portions of the plurality of segments based on the first time domain granularity, the capability indication information may be indicated by two bits, e.g., the correspondence between the indication information and the capability is shown in Table 1 below.

TABLE 1

| Capability | |
|---|---|
| indication | |
| information | Capability |
| 00 | Not supporting the uplink transmission timing advance pre- |
| | compensation for segment-based transmission |
| 01 | Supporting the uplink transmission timing advance pre- |
| | compensation for segment-based transmission, and |
| | supporting puncturing or dropping the overlapping portions |
| | of the plurality of segments based on the time domain |
| | symbol |
| 10 | Supporting the uplink transmission timing advance pre- |
| | compensation for segment-based transmission, and |
| | supporting puncturing or dropping the overlapping portions |
| | of the plurality of segments based on the time slot/the |
| | subframe |
| 11 | reserve |

As shown in Table 1, when the capability indication information is “00”, which indicates that the terminal does not support the uplink transmission timing advance pre-compensation for segment-based transmission; when the capability indication information is “01”, which indicates that the terminal supports the uplink transmission timing advance pre-compensation for segment-based transmission, and supports puncturing or dropping the overlapping portions of the plurality of segments based on the time domain symbol; when the capability indication information is “10”, which indicates that the terminal supports the uplink transmission timing advance pre-compensation for segment-based transmission, and supports puncturing or dropping the overlapping portions of the plurality of segments based on the time slot/the subframe; “11” can be used as a reserve, and a capability indicated by “11” can be set subsequently as required.

FIG. 5 is a flowchart illustrating a capability indication method according to another embodiment of the present disclosure. As shown in FIG. 5, the method further includes the following steps S501 to S502.

At step S501, it is determined that the uplink transmission timing advance pre-compensation for segment-based transmission is not supported.

At step S502, receiving a scheduling instruction with a transmission duration greater than a preset duration is not expected.

In an embodiment, when the terminal determines that the uplink transmission timing advance pre-compensation for segment-based transmission is not supported, the uplink transmission carried out in general is no longer than a preset duration in the time domain, so that a transmission duration for the uplink transmission is not too large, e.g., not larger than the preset duration. Therefore, the terminal cannot expect to receive a scheduling instruction with a transmission duration greater than the preset duration.

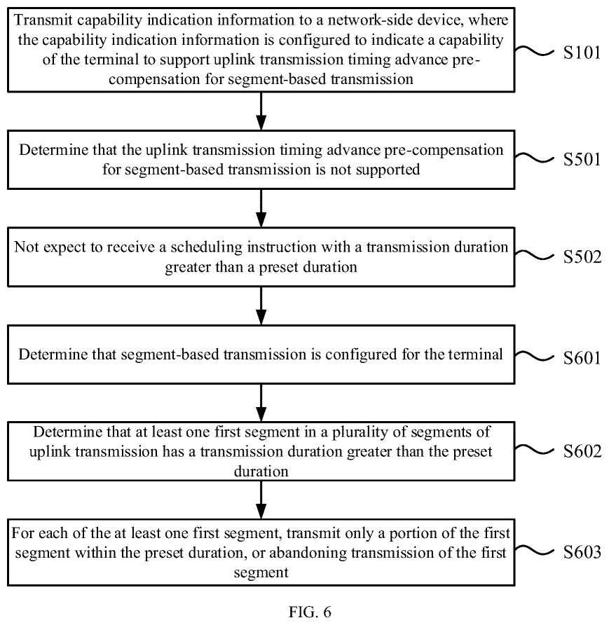

FIG. 6 is a flowchart illustrating a capability indication method according to still another embodiment of the present disclosure. As shown in FIG. 6, the method further includes the following steps S601 to S603.

At step S601, it is determined that the segment-based transmission is configured for the terminal.

At step S602, it is determined that at least one first segment of a plurality of segments of uplink transmission has a transmission duration greater than the preset duration.

At step S603, only a portion of the at least one first segment within the preset duration is transmitted, or transmission of the at least one first segment is abandoned.

In an embodiment, when the terminal determines that the uplink transmission timing advance pre-compensation for segment-based transmission is not supported, although the network-side device can determine, based on the capability indication information, that the terminal does not support the uplink transmission timing advance pre-compensation for segment-based transmission, the network-side device generally does not transmit the scheduling instruction, with a transmission duration greater than a preset duration, to the terminal.

However, the network-side device may still configure the terminal to perform segment-based transmission. For example, perform the uplink transmission after dividing a regular PUSCH into the plurality of segments. In this case, since the terminal does not perform long PUSCH uplink transmission, the transmission duration of each uplink transmission is not greater than the preset duration.

Therefore, even if there is a first segment with a transmission duration greater than the preset duration, for the first segment, only the portion within the preset duration range of the first segment is transmitted. For example, only the portion of the first segment that continues for the preset duration from the starting time domain position is transmitted. Alternatively, for the first segment with a transmission duration greater than the preset duration, the terminal can directly abandon the transmission of the first segment. Accordingly, problems arising from uplink transmission in excess of the capability of the terminal can be avoided.

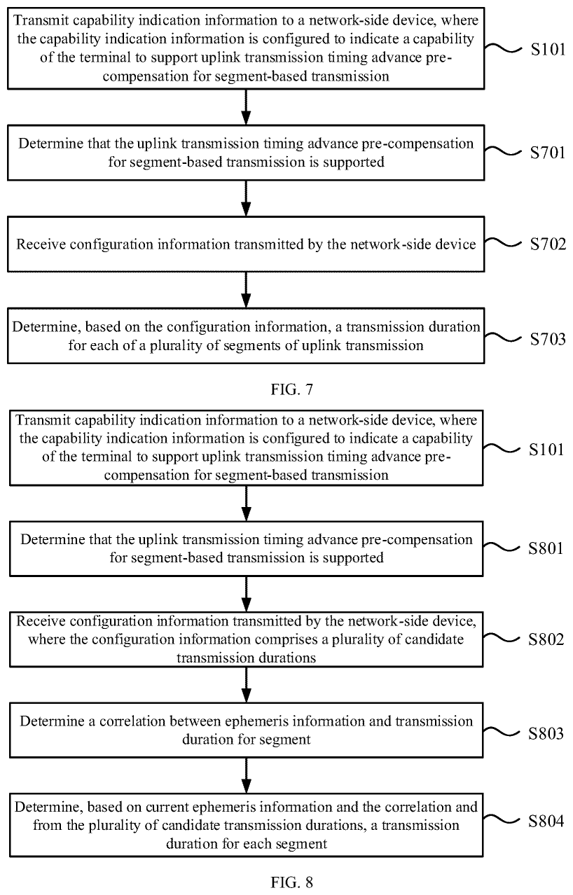

FIG. 7 is a flowchart illustrating a capability indication method according to still another embodiment of the present disclosure. As shown in FIG. 7, the method further includes the following steps S701 to S703.

At step S701, it is determined that the uplink transmission timing advance pre-compensation for segment-based transmission is supported.

At step S702, configuration information transmitted by the network-side device is received.

At step S703, a transmission duration for each of a plurality of segments of uplink transmission is determined based on the configuration information.

The configuration information includes, but is not limited to, radio resource control (RRC) signaling, media access control layer control element (MAC CE), physical layer signaling, and the like.

In an embodiment, when the terminal determines that the uplink transmission timing advance pre-compensation for segment-based transmission is supported, the uplink transmission can include the transmission of uplink information carrying the PUSCH or other uplink channels, so that the transmission duration for the uplink transmission can be relatively large, and the network-side device can also configure the segment-based transmission for the terminal.

In this case, the terminal can divide the uplink transmission into a plurality of segments, and the network-side device can transmit configuration information to the terminal, and configure a transmission duration for each segment for the terminal through the configuration information. Accordingly, the terminal can determine the transmission duration for each segment according to the transmission duration in the configuration information.

FIG. 8 is a flowchart illustrating a capability indication method according to still another embodiment of the present disclosure. As shown in FIG. 8, the method further includes the following steps S801 to S804.

At step S801, it is determined that the uplink transmission timing advance pre-compensation for segment-based transmission is supported.

At step S801, configuration information transmitted by the network-side device is received, where the configuration information includes a plurality of candidate transmission durations.

At step S803, it is determined that a correlation between ephemeris information and transmission duration for segment.

At step S804, a transmission duration, corresponding to each segment, in the plurality of candidate transmission durations is determined based on current ephemeris information and the correlation.

In an embodiment, when the terminal determines that the uplink transmission timing advance pre-compensation for segment-based transmission is supported, the uplink transmission can include the transmission of uplink information carrying the PUSCH or other uplink channels, so that the transmission duration for the uplink transmission can be relatively large, and the network-side device can also configure the segment-based transmission for the terminal.

In this case, the terminal can divide the uplink transmission into a plurality of segments, and the network-side device can transmit the configuration information to the terminal, and configure the plurality of candidate transmission durations for the terminal through the configuration information, subsequently, the terminal can further determine the transmission duration for each segment from the plurality of candidate transmission durations.

In an embodiment, there may be a correlation between ephemeris information and transmission duration for a segment. For example, there may be a correlation between tilt angle in ephemeris information and transmission duration for the segment.

Due to the relatively large tilt angle of the satellite, as the satellite moves, the transmission distance of the signal transmitted by the satellite to the terminal will change faster. Therefore, it is necessary to synchronize more frequently based on the transmission distance (such as compensating for timing advance). Therefore, the transmission duration for each segment can be set relatively small to synchronize more frequently for each segment, and correspondingly, the smaller the tilt angle of the satellite, the longer the transmission duration for the segment can be. Therefore, the correlation can include a negative correlation between tilt angle and transmission duration for segment. The network-side device may configure the correlation to the terminal. For example, via the configuration information.

The terminal can determine the ephemeris information of the current satellite. For example, they are based on the information broadcast by the satellite, such that a transmission duration, corresponding to each segment, in the plurality of candidate transmission durations is determined based on current ephemeris information and the correlation.

For example, the correlation between tilt angle in ephemeris information and transmission duration includes an angle A corresponding to a transmission duration T1, and an angle B corresponding to a transmission duration T2. Therefore, when determining that the tilt angle in the ephemeris information of the current satellite is the angle A, the transmission duration T1 corresponding to the angle A can be determined from the candidate transmission durations as the transmission duration for each segment.

If the tilt angle of angle C in the ephemeris information of the current satellite does not exist in the correlation, the terminal can determine an angle closest to the angle C in the correlation, such as the angle B, and thus determine the transmission duration T2 corresponding to the angle B as a transmission duration for each segment.

In an embodiment, the method further includes: determining, based on the terminal, a transmission duration, corresponding to each segment, in the plurality of candidate transmission durations.

The terminal can not only determine the transmission duration for each segment from the candidate transmission durations according to the correlation between ephemeris information and transmission duration, but also select one of the candidate transmission durations as the transmission duration from each segment according to the terminal itself.

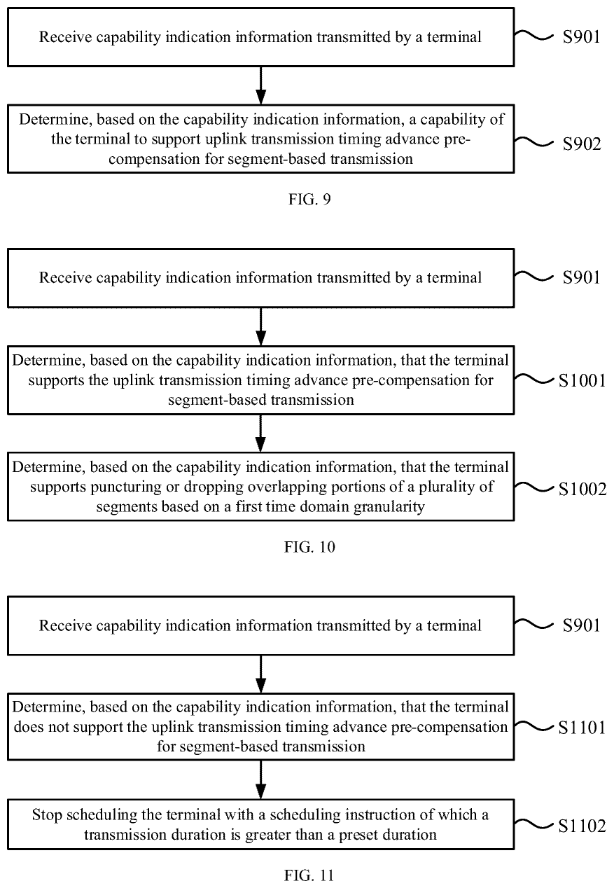

FIG. 9 is a flowchart illustrating a capability determination method according to an embodiment of the present disclosure. The capability determination method shown in this embodiment can be performed by a network-side device, which can communicate with a terminal. The network-side device includes, but is not limited to, a base station (such as a 4G base station, a 5G base station, a 6G base station and the like) in a communication system. The terminal includes, but is not limited to, a communication device such as a mobile phone, a tablet, a wearable device, a sensor, and an IoT device.

As shown in FIG. 9, the method may include the following steps S901 to S902.

At step S901, capability indication information transmitted by a terminal is received.

At step S902, a capability of the terminal to support uplink transmission timing advance pre-compensation for segment-based transmission is determined based on the capability indication information.

In an embodiment, the terminal may determine its own capability to support the uplink transmission timing advance pre-compensation for segment-based transmission, and the capability includes supporting the uplink transmission timing advance pre-compensation for segment-based transmission, and not supporting the uplink transmission timing advance pre-compensation for segment-based transmission. Further, the capability indication information is transmitted to the network-side device, and the network-side device may determine, based on the capability indication information, the capability of the terminal to support the uplink transmission timing advance pre-compensation for segment-based transmission. For example, the network-side device can determine whether the terminal supports the uplink transmission timing advance pre-compensation for segment-based transmission or not.

For example, the capability can be indicated by one bit, where “1” means that the terminal supports the uplink transmission timing advance pre-compensation for segment-based transmission, and “0” means that the terminal does not support the uplink transmission timing advance pre-compensation for segment-based transmission.

According to the present disclosure, that the network-side device determines the capability of the terminal to support the uplink transmission timing advance pre-compensation for segment-based transmission can be ensure, such that the terminal can be appropriately configured based on the capability of the terminal to support the uplink transmission timing advance pre-compensation for segment-based transmission, therefore good communication quality is ensured.

FIG. 10 is a flowchart illustrating a capability determination method according to another embodiment of the present disclosure. As shown in FIG. 10, the determining, based on the capability indication information, the capability of the terminal to support the uplink transmission timing advance pre-compensation for segment-based transmission includes:

At step S1001, that the terminal supports the uplink transmission timing advance pre-compensation for segment-based transmission is determined based on the capability indication information;
where the method further includes:

At step S1002, that the terminal supports puncturing or dropping overlapping portions of a plurality of segments based on a first time domain granularity is determined based on the capability indication information.

In an embodiment, the terminal performs the uplink transmission on time domain resource, which include a plurality of time domain granularities from large to small, and puncturing or dropping the overlapping portions of the plurality of segments by the terminal may be puncturing or dropping the overlapping portions of the plurality of segments based on a first time domain granularity, i.e., determining a time domain resource of the first time domain granularity corresponding to the overlapping portion, and then puncturing or dropping information within the determined time domain resource of the segment where the overlapping portion to be punctured or dropped is.

However, due to different capabilities of different terminals, some terminals can puncture or drop a relatively large amount of information, i.e., the first time domain granularity is relatively large when the overlapping portions of the plurality of segments are punctured or dropped based on the first time domain granularity; some terminals can only puncture or drop relatively little information, i.e., the first time domain granularity is relatively small when the overlapping portions of the plurality of segments are punctured or dropped based on the first time domain granularity.

Thus, the terminal may indicate, by the capability indication information, that the terminal supports puncturing or dropping the overlapping portions of the plurality of segments based on the first time domain granularity, such that the network-side device can determine the first time domain granularity, and thereby determine a size of the time domain granularity on which the terminal can puncture or drop the overlapping portions of the segments, so that the network-side device can appropriately configure the terminal based on the first time domain granularity, therefore good communication quality is ensured.

In an embodiment, the first time domain granularity includes at least one of:
a time domain symbol, a time slot, or a subframe.

Illustrated by the example of the embodiment shown in FIG. 3, the portion of the pre-compensated segment 2 overlapping with the segment 1 corresponds to six time domain symbols. When the first time domain granularity is a time domain symbol, it may determine that the terminal punctures or drops only the overlapping portion of the segment 2. When the first time domain granularity is a time slot, it may determine a time slot in which the six time domain symbols are located, and thus further determine that the terminal punctures or drops the information of the segment 2 in this time slot. When the first time domain granularity is a subframe, it may determine a subframe in which the six time domain symbols are located, and thus further determine that the terminal punctures or drops the information of the segment 2 in this subframe.

FIG. 11 is a flowchart illustrating a capability determination method according to yet another embodiment of the present disclosure. As shown in FIG. 11, the determining, based on the capability indication information, the capability of the terminal to support the uplink transmission timing advance pre-compensation for segment-based transmission includes:

At step S1101, that the terminal does not support the uplink transmission timing advance pre-compensation for segment-based transmission is determined based on the capability indication information;
where the method further includes:

At step S1102, scheduling, based on a scheduling instruction with a transmission duration greater than a preset duration, the terminal is stopped.

In an embodiment, when the terminal determines that the uplink transmission timing advance pre-compensation for segment-based transmission is not supported, the uplink transmission carried out in general is no longer than a preset time length in the time domain, so that the transmission time length corresponding to the uplink transmission is not too large, e.g., not larger than the preset time length. Therefore, the terminal cannot expect to receive a scheduling instruction with a transmission duration greater than the preset duration. Accordingly, the network-side device may stop scheduling, based on a scheduling instruction with a transmission duration greater than a preset duration, the terminal.

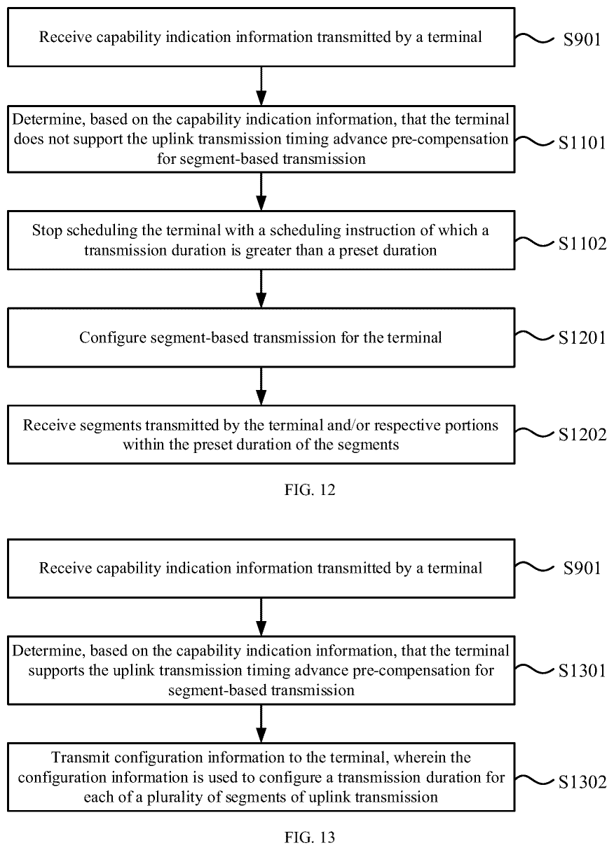

FIG. 12 is a flowchart illustrating a capability determination method according to yet another embodiment of the present disclosure. As shown in FIG. 12, the method further includes the following steps S1201 to S1202.

At step S1201, the segment-based transmission is configured for the terminal.

At step S1202, segments transmitted by the terminal and/or a portion of the segments within the preset duration is received.

In an embodiment, when the terminal determines that the uplink transmission timing advance pre-compensation for segment-based transmission is not supported, although the network-side device can determine, based on the capability indication information, that the terminal does not support the uplink transmission timing advance pre-compensation for segment-based transmission, the network-side device generally does not transmit the scheduling instruction, with a transmission duration greater than a preset duration, to the terminal.

However, the network-side device may still configure the terminal to perform segment-based transmission. For example, perform the uplink transmission after dividing a regular PUSCH into the plurality of segments. In this case, since the terminal does not perform long PUSCH uplink transmission, the transmission duration of each uplink transmission is not greater than the preset duration.

Therefore, even if there is a first segment with a transmission duration greater than the preset duration, for the first segment, only the portion within the preset duration range of the first segment is transmitted. For example, only the portion of the first segment that continues for the preset duration from the starting time domain position is transmitted. Accordingly, problems arising from uplink transmission in excess of the capability of the terminal can be avoided. Correspondingly, the network-side device can only receive the portion of the first segment within the preset duration.

FIG. 13 is a flowchart illustrating a capability determination method according to yet another embodiment of the present disclosure. As shown in FIG. 13, the determining, based on the capability indication information, the capability of the terminal to support the uplink transmission timing advance pre-compensation for segment-based transmission includes:

At step S1301, that the terminal supports the uplink transmission timing advance pre-compensation for segment-based transmission is determined based on the capability indication information.
where the method further includes:

At step S1302, configuration information is transmitted to the terminal, where the configuration information is used to configure a transmission duration for each of a plurality of segments of uplink transmission.

In an embodiment, when the terminal determines that the uplink transmission timing advance pre-compensation for segment-based transmission is supported, the uplink transmission can include the transmission of uplink information carrying the PUSCH or other uplink channels, so that the transmission duration for the uplink transmission can be relatively large, and the network-side device can also configure the segment-based transmission for the terminal.

In this case, the terminal can divide the uplink transmission into a plurality of segments, and the network-side device can transmit configuration information to the terminal, and configure a transmission duration for each segment based on the configuration information for the terminal, accordingly, the terminal can determine the transmission duration for each segment according to the transmission duration in the configuration information.

In an embodiment, the determining, based on the capability indication information, the capability of the terminal to support the uplink transmission timing advance pre-compensation for segment-based transmission includes:
determining, based on the capability indication information, that the terminal supports the uplink transmission timing advance pre-compensation for segment-based transmission;
where the method further includes:
transmitting configuration information to the terminal, where the configuration information includes a plurality of candidate transmission durations, and the configuration information is used to configure a correlation between ephemeris information and transmission duration.

In an embodiment, when the terminal determines that the uplink transmission timing advance pre-compensation for segment-based transmission is supported, the uplink transmission can include the transmission of uplink information carrying the PUSCH or other uplink channels, so that the transmission duration for the uplink transmission can be relatively large, and the network-side device can also configure the segment-based transmission for the terminal.

In this case, the terminal can divide the uplink transmission into a plurality of segments, and the network-side device can transmit the configuration information to the terminal, and configure the plurality of candidate transmission durations for the terminal through the configuration information, subsequently, the terminal can further determine the transmission duration for each segment from the plurality of candidate transmission durations.

In an embodiment, there may be a correlation between ephemeris information and transmission duration for segment. For example, specifically there may be a correlation between tilt angle in ephemeris information and transmission duration for segment.

Due to the relatively large tilt angle of the satellite, as the satellite moves, the transmission distance of the signal transmitted by the satellite to the terminal will change faster. Therefore, it is necessary to synchronize more frequently based on the transmission distance (such as compensating for timing advance). Therefore, the transmission duration for each segment can be set relatively small to synchronize more frequently for each segment, and correspondingly, the smaller the tilt angle of the satellite, the longer the transmission duration for the segment can be. Therefore, the correlation can include a negative correlation between tilt angle and transmission duration for segment. The network-side device may configure the correlation to the terminal. For example, via the configuration information.

The terminal can determine the ephemeris information of the current satellite. For example, based on the information broadcast by the satellite, such that a transmission duration, corresponding to each segment, in the plurality of candidate transmission durations is determined based on current ephemeris information and the correlation.

For example, the correlation between tilt angle in ephemeris information and transmission duration includes an angle A corresponding to a transmission duration T1, and an angle B corresponding to a transmission duration T2. Therefore, when determining that the tilt angle in the ephemeris information of the current satellite is the angle A, the transmission duration T1 corresponding to the angle A can be determined from the candidate transmission durations as the transmission duration for each segment.

If the tilt angle of angle C in the ephemeris information of the current satellite does not exist in the correlation, the terminal can determine an angle closest to the angle C in the correlation, such as the angle B, and thus determine the transmission duration T2 corresponding to the angle B as a transmission duration for each segment.

The present disclosure also provides embodiments of a capability indication apparatus and a capability determination apparatus corresponding to the foregoing embodiments of the capability indication and capability determination methods, respectively.

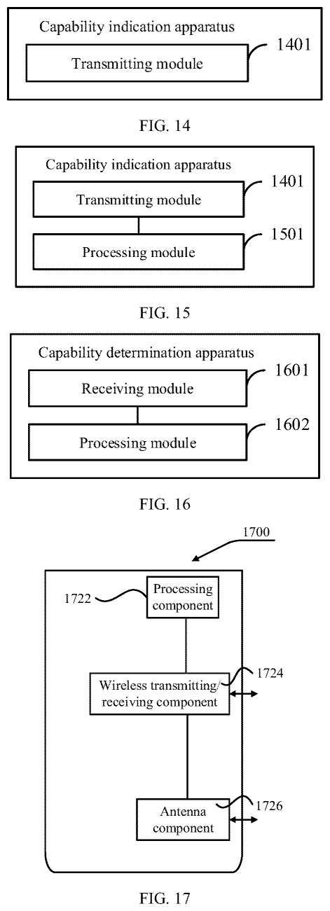

FIG. 14 is a block diagram illustrating a capability indication apparatus according to an embodiment of the present disclosure. The capability indication apparatus shown in this embodiment may be applied to a terminal. The terminal includes, but is not limited to, a communication device such as a cell phone, a tablet, a wearable device, a sensor, an internet of things (IoT) device, and the like. The terminal may communicate with a network-side device, the network-side device includes, but is not limited to a network-side device (such as a base station, a core network, and the like) in a communication system such as a 4th generation (4G) communication system, 5G communication system, 6G communication system, etc.

As shown in FIG. 14, the apparatus may include a transmitting module 1401.

The transmitting module 1401 is configured to transmit capability indication information to a network-side device, where the capability indication information is configured to indicate a capability of a terminal to support uplink transmission timing advance pre-compensation for segment-based transmission.

FIG. 15 is a block diagram illustrating a capability indication apparatus according to another embodiment of the present disclosure. As shown in FIG. 15, the apparatus further includes a processing module 1501.

The processing module 1501 is configured to puncture or drop, when a plurality of segments of uplink transmission overlap, overlapping portions of the plurality of segments.

In an embodiment, the capability indication information, when indicating that the terminal supports the uplink transmission timing advance pre-compensation for segment-based transmission, is further configured to indicate that the terminal supports puncturing or dropping the overlapping portions of the plurality of segments based on a first time domain granularity.

In an embodiment, the first time domain granularity includes at least one of:
a time domain symbol, a time slot, or a subframe.

In an embodiment, the apparatus further includes a processing module.

The processing module is configured to determine that the uplink transmission timing advance pre-compensation for segment-based transmission is not supported, and that receiving a scheduling instruction with a transmission duration greater than a preset duration is not expected.

In an embodiment, the apparatus further includes a processing module.

The processing module is configured to determine that segment-based transmission is configured for the terminal;
determine that at least one first segment of a plurality of segments of uplink transmission has a transmission duration greater than the preset duration; and
transmit only a portion of the at least one first segment within the preset duration, or abandon transmission of the at least one first segment.

In an embodiment, the apparatus further includes a processing module and a receiving module.

The processing module is configured to determine that the uplink transmission timing advance pre-compensation for segment-based transmission is supported.

The receiving module is configured to receive configuration information transmitted by the network-side device.

Based on the configuration information, the processing module is further configured to determine a transmission duration for each of a plurality of segments of uplink transmission.

In an embodiment, the apparatus further includes a processing module and a receiving module.

The processing module is configured to determine the support of the uplink transmission timing advance pre-compensation for segment-based transmission.

The receiving module is configured to receive configuration information transmitted by the network-side device, where the configuration information includes a plurality of candidate transmission durations.

The processing module is further configured to determine a correlation between ephemeris information and transmission duration for segment, and, based on current ephemeris information and the correlation, determine a transmission duration for each segment from the plurality of candidate transmission durations.

In an embodiment, the apparatus further includes a processing module, configured to determine that the uplink transmission timing advance pre-compensation for segment-based transmission is supported.

The receiving module is configured to receive configuration information transmitted by the network-side device, where the configuration information includes a plurality of candidate transmission durations.

The processing module is further configured to determine, based on the terminal, a transmission duration, corresponding to each segment, in the plurality of candidate transmission durations.

FIG. 16 is a block diagram illustrating a capability determination apparatus according to an embodiment of the present disclosure. The capability determination apparatus shown in this embodiment can be applied to a network-side device, which can communicate with a terminal. The network-side device includes, but is not limited to, a base station (such as a 4G base station, a 5G base station, a 6G base station and the like) in a communication system. The terminal includes, but is not limited to, a communication device such as a mobile phone, a tablet, a wearable device, a sensor, and an IoT device.

As shown in FIG. 16, the apparatus may include a receiving module 1601 and a processing module 1602.

The receiving module 1601 is configured to receive capability indication information transmitted by a terminal.

Based on the capability indication information, the processing module 1602 is configured to determine a capability of the terminal to support uplink transmission timing advance pre-compensation for segment-based transmission.

In an embodiment, the processing module is configured to determine, based on the capability indication information, the capability of the terminal to support the uplink transmission timing advance pre-compensation for segment-based transmission.

Based on the capability indication information, the processing module is further configured to determine that the terminal supports puncturing or dropping overlapping portions of the plurality of segments based on a first time domain granularity.

In an embodiment, the first time domain granularity includes at least one of:
a time domain symbol, a time slot, or a subframe.

In an embodiment, the processing module is configured to determine, based on the capability indication information, that the terminal does not support the uplink transmission timing advance pre-compensation for segment-based transmission.

The processing module is further configured to stop scheduling, based on a scheduling instruction with a transmission duration greater than a preset duration, the terminal.

In an embodiment, the processing module is further configured to configure the segment-based transmission for the terminal.

The receiving module is further configured to receive segments transmitted by the terminal and/or a portion of the segments within the preset duration.

In an embodiment, the processing module is configured to determine, based on the capability indication information, the capability of the terminal to support the uplink transmission timing advance pre-compensation for segment-based transmission.

The apparatus further includes a transmitting module.

The transmitting module is configured to transmit configuration information to the terminal, where the configuration information is used to configure a transmission duration for each of a plurality of segments of uplink transmission.

In an embodiment, the processing module is configured to determine, based on the capability indication information, that the terminal supports the uplink transmission timing advance pre-compensation for segment-based transmission.

The apparatus further includes a transmitting module.

The transmitting module is configured to transmit configuration information to the terminal, where the configuration information includes a plurality of candidate transmission durations, and the configuration information is used to configure a correlation between ephemeris information and transmission duration.

With regard to the device in the above examples, the specific manner in which the respective modules perform the operations has been described in detail in the examples of the related methods, and will not be explained in detail herein.

Since the apparatus's embodiments substantially correspond to the embodiments of the method, relevant parts may be referred to the description of the embodiments of the method. The apparatus examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the examples. It may be understood and implemented by those skilled in the art without creative work.

An embodiment of the present disclosure further provides a communication device, including: a processor; and a memory storing computer programs, where the computer programs, when executed by the processor, cause the processor to perform the capability indication method according to any one of the embodiments of the present disclosure.

An embodiment of the present disclosure further provides a communication device, including: a processor; and a memory storing computer programs, where the computer programs, when executed by the processor, cause the processor to perform the capability determination method according to any one of the embodiments of the present disclosure.

An embodiment of the present disclosure further provides a computer-readable storage medium, storing computer programs thereon, where the computer programs, when executed by a processor, cause the processor to perform the capability indication method according to any one of the embodiments of the present disclosure.

An embodiment of the present disclosure further provides a computer-readable storage medium, storing computer programs thereon, where the computer programs, when executed by a processor, cause the processor to perform the capability determination method according to any one of the embodiments of the present disclosure.

FIG. 17 is a block diagram illustrating a device 1700 for determining a capability according to an embodiment of the present disclosure. The device 1700 may be provided as a base station. Referring to FIG. 17, the device 1700 includes a processing component 1722, a wireless transmitting/receiving component 1724, an antenna component 1726, and a signal processing portion specific to a wireless interface. The processing component 1722 may further include one or more processors. One of the processors in the processing component 1722 may be configured to perform the capability determination method in any one of the embodiments.

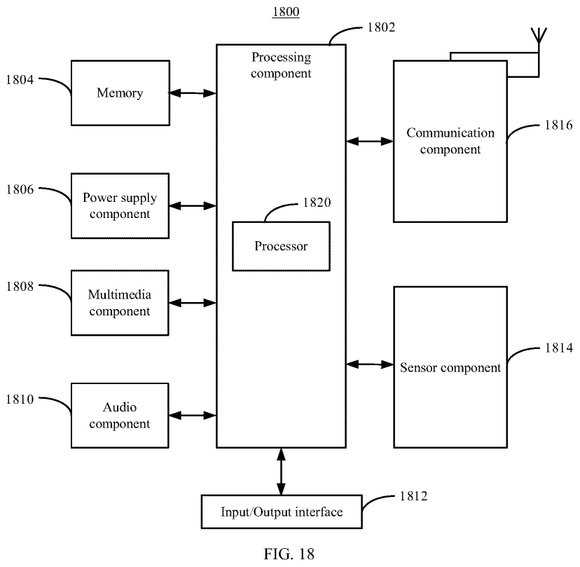

FIG. 18 is a block diagram illustrating a device 1800 to indicate a capability according to an embodiment of the present disclosure. For example, the device 1800 can be a mobile phone, a computer, a digital broadcast terminal, a message transmitting and receiving device, a gaming console, a tablet device, a medical device, a fitness device, a personal digital assistant, and the like.

Referring to FIG. 18, the device 1800 can include one or more of the following components: a processing component 1802, a memory 1804, a power supply component 1806, a multimedia component 1808, an audio component 1810, an input/output (I/O) interface 1812, a sensor component 1814, and a communication component 1816.

The processing component 1802 usually controls overall operations of the device 1800, such as operations related to display, a telephone call, data communication, a camera operation and a record operation. The processing component 1802 may include one or more processors 1820 to execute instructions to complete all or a part of the steps of the capability indication method. Further, the processing component 1802 may include one or more modules to facilitate interaction between the processing component 1802 and another component. For example, the processing component 1802 may include a multimedia module to facilitate the interaction between the multimedia component 1808 and the processing component 1802.

The memory 1804 is configured to store different types of data to support the operations of the device 1800. Examples of such data include instructions, contact data, phone book data, messages, pictures, videos, and so on for any application or method that operates on the device 1800. The memory 1804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or optical disk.

The power supply component 1806 provides power for different components of the device 1800. The power supply component 1806 may include a power management system, one or more power sources, and other components associated with generating, managing and distributing power for the device 1800.

The multimedia component 1808 includes a screen for providing an output interface between the device 1800 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 1808 may include a front camera and/or a rear camera. When the device 1800 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 1810 is configured to output and/or input an audio signal. For example, the audio component 1810 may include a microphone (MIC). When the device 1800 is in an operating mode, such as a call mode, a recording mode and a speech recognition mode, the microphone is configured to receive an external audio signal. The received audio signal may be further stored in the memory 1804 or sent via the communication component 1816. In some embodiments, the audio component 1810 also includes a speaker for outputting an audio signal.

The I/O interface 1812 provides an interface between the processing component 1802 and a peripheral interface module which may be a keyboard, a click wheel, a button, or the like. Such buttons may include but not limited to: a home button, a volume button, a start button and a lock button.

The sensor component 1814 includes one or more sensors for providing state assessments in different aspects for the device 1800. For example, sensor component 1814 can detect an open/closed state of device 1800, a relative positioning of components, such as the display and keypad of device 1800, and sensor component 1814 can also detect a change in position of device 1800 or a component of device 1800, the presence or absence of user contact with device 1800, orientation or acceleration/deceleration of device 1800, and temperature change of device 1800. The sensor component 1814 may include a proximity sensor configured to detect presence of a nearby object without any physical contact. The sensor component 1814 may also include an optical sensor, such as a CMOS or CCD image sensor used in an imaging application. In some examples, the sensor component 1814 may also include an acceleration sensor, a gyro sensor, a magnetic sensor, a pressure sensor, or a temperature sensor.

The communication component 1816 is configured to facilitate wired or wireless communication between the device 1800 and other devices. The device 1800 may access a wireless network based on a communication standard, such as WiFi, 2G, 3G, 4G LTE, 5G NR, or a combination thereof. In some embodiments, the communication component 1816 may receive a broadcast signal or broadcast-related information from an external broadcast management system via a broadcast channel. In an example, the communication component 1816 may also include a near field communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology, and other technologies.

In an example, the device 1800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the Capability method in any one of the above examples.

In an example, a non-transitory computer readable storage medium including instructions, such as the memory 1804 including instructions, is also provided. The above instructions may be executed by the processor 1820 of the device 1800 to complete the capability indication method. For example, the non-transitory computer readable storage medium may be a read-only memory (ROM), a random access memory (RAM), a CD-ROM, a magnetic tape, a floppy disk and an optical data storage device, etc.

According to the present disclosure, that the network-side device determines the capability of the terminal to support the uplink transmission timing advance pre-compensation based on the segment transmission can be ensure, such that the terminal can be appropriately configured based on the capability of the terminal to support the uplink transmission timing advance pre-compensation based on the segment transmission, therefore good communication quality is ensured.

After considering the specification and practicing the present disclosure, the persons of skill in the prior art may easily conceive of other implementations of the present disclosure. The present disclosure is intended to cover any variations, uses, modification or adaptations of the present disclosure that follow the general principles thereof and include common knowledge or conventional technical means in the art that are not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the disclosure is to be limited only by the appended claims.

It shall be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The methods and apparatuses of the present disclosure are described above in detail. The principle and implementation of the present disclosure are described herein through specific examples. The description about the embodiments of the present disclosure is merely provided for ease of understanding of the method and core ideas of the present disclosure. Persons of ordinary skill in the art can make variations and modifications to the present disclosure in terms of the specific implementations and application scopes according to the ideas of the present disclosure. Therefore, the specification shall not be construed as a limit to the present disclosure.

1. A capability indication method, performed by a terminal, and comprising:
transmitting capability indication information to a network-side device, wherein the capability indication information is configured to indicate a capability of the terminal to support uplink transmission timing advance pre-compensation for segment-based transmission.

2. The capability indication method of claim 1, further comprising:
puncturing or dropping, overlapping portions of a plurality of segments of uplink transmission, wherein the plurality of segments of uplink transmission overlap.

3. The capability indication method of claim 2, wherein, in addition to indicating that the terminal supports the uplink transmission timing advance pre-compensation for segment-based transmission, the capability indication information is further configured to indicate that the terminal supports puncturing or dropping the overlapping portions of the plurality of segments based on a first time domain granularity.

4. The capability indication method of claim 3, wherein the first time domain granularity comprises at least one of: a time domain symbol, a time slot, or a subframe.

5. The capability indication method of claim 1, further comprising:
determining that the uplink transmission timing advance pre-compensation for segment-based transmission is not supported; and
not expecting to receive a scheduling instruction with a transmission duration greater than a preset duration.

6. The capability indication method of claim 5, further comprising:
determining that segment-based transmission is configured for the terminal;
determining that at least one first segment in a plurality of segments of uplink transmission has a transmission duration greater than the preset duration; and
for each of the at least one first segment, transmitting only a portion of the first segment within the preset duration, or abandoning transmission of the first segment.

7. The capability indication method of claim 1, further comprising:
determining that the uplink transmission timing advance pre-compensation for segment-based transmission is supported;
receiving configuration information transmitted by the network-side device; and
determining, based on the configuration information, a transmission duration for each of a plurality of segments of uplink transmission.

8. The capability indication method of claim 1, further comprising:
determining that the uplink transmission timing advance pre-compensation for segment-based transmission is supported;
receiving configuration information transmitted by the network-side device, wherein the configuration information comprises a plurality of candidate transmission durations;
determining a correlation between ephemeris information and transmission duration for segment; and
determining, based on current ephemeris information and the correlation and from the plurality of candidate transmission durations, a transmission duration for each segment.

9. The capability indication method of claim 1, further comprising:
determining that the uplink transmission timing advance pre-compensation for segment-based transmission is supported;
receiving configuration information transmitted by the network-side device, wherein the configuration information comprises a plurality of candidate transmission durations; and
determining, based on the terminal and from the plurality of candidate transmission durations, a transmission duration for each segment.

10. A capability determination method, performed by a network-side device, and comprising:
receiving capability indication information transmitted by a terminal; and
determining, based on the capability indication information, a capability of the terminal to support uplink transmission timing advance pre-compensation for segment-based transmission.

11. The capability determination method of claim 10, wherein the determining, based on the capability indication information, the capability of the terminal to support the uplink transmission timing advance pre-compensation for segment-based transmission, comprises:
determining, based on the capability indication information, that the terminal supports the uplink transmission timing advance pre-compensation for segment-based transmission;
wherein the capability determination-method further comprises:
determining, based on the capability indication information, that the terminal supports puncturing or dropping overlapping portions of a plurality of segments based on a first time domain granularity.

12. The capability determination method of claim 11, wherein the first time domain granularity comprises at least one of: a time domain symbol, a time slot, or a subframe.

13. The capability determination method of claim 10, wherein the determining, based on the capability indication information, the capability of the terminal to support the uplink transmission timing advance pre-compensation for segment-based transmission comprises:
determining, based on the capability indication information, that the terminal does not support the uplink transmission timing advance pre-compensation for segment-based transmission;
wherein the capability determination method further comprises:
stopping scheduling the terminal with a scheduling instruction of which a transmission duration is greater than a preset duration.

14. The capability determination method of claim 13, further comprising:
configuring segment-based transmission for the terminal; and
receiving segments transmitted by the terminal or respective portions within the preset duration of the segments.

15. The capability determination-method of claim 10, wherein the determining, based on the capability indication information, the capability of the terminal to support the uplink transmission timing advance pre-compensation for segment-based transmission comprises:
determining, based on the capability indication information, that the terminal supports the uplink transmission timing advance pre-compensation for segment-based transmission;
wherein the capability determination method further comprises:
transmitting configuration information to the terminal, wherein the configuration information is used to configure a transmission duration for each of a plurality of segments of uplink transmission.

16. The capability determination method of claim 10, wherein the determining, based on the capability indication information, the capability of the terminal to support the uplink transmission timing advance pre-compensation for segment-based transmission comprises:
determining, based on the capability indication information, that the terminal supports the uplink transmission timing advance pre-compensation for segment-based transmission;
wherein the capability determination method further comprises:
transmitting configuration information to the terminal, wherein the configuration information comprises a plurality of candidate transmission durations, and the configuration information is used to configure a correlation between ephemeris information and transmission duration.

17. (canceled)

18. (canceled)

19. A communication device, comprising:
one or more processors; and
a memory storing computer programs,
wherein the computer programs, when executed by the one or more processors, collectively cause the one or more processors to perform operations comprising:
transmitting capability indication information to a network-side device, wherein the capability indication information is configured to indicate a capability of a terminal to support uplink transmission timing advance pre-compensation for segment-based transmission.

20. A communication device, comprising:
one or more processors; and
a memory storing computer programs,
wherein the computer programs, when executed by the one or processors, cause the one or more processors to collectively perform the capability determination method of claim 10.

21. A non-transitory computer-readable storage medium, storing computer programs thereon, wherein the computer programs, when executed by a processor, cause the processor to perform the capability indication method of claim 1.

22. A non-transitory computer-readable storage medium, storing computer programs thereon, wherein the computer programs, when executed by a processor, cause the processor to perform the capability determination method of claim 10.
